(19) United States
(12) Patent Application Publication
(10) Pub. No.: US 2026/0336421 A1
(43) Pub. Date: Oct. 29, 2026

(54) VEHICLE BRAKE SYSTEM, VEHICLE INCLUDING VEHICLE BRAKE SYSTEM, AND METHOD FOR OPERATING A VEHICLE

(71) Applicant: ZERO MOTORCYCLES, INC., Scotts Valley, CA (US)

(72) Inventor: Ryan BIFFARD, Kelowna, BC (CA)

(21) Appl. No.: 19/123,244

(22) PCT Filed: Oct. 17, 2023
(86) PCT No.: PCT/US2023/077050

§ 371 Date: Apr. 22, 2025

Related U.S. Application Data
(60) Provisional application No. 63/418,830, filed on Oct. 24, 2022.

(51) Int. Cl. B60L 7/26; B60L 7/18; B60L 58/15; B62J 45/41; B62L 3/02; B62L 3/04; F16D 55/226; F16D 121/04

(52) U.S. Cl. CPC B60L 7/26; B60L 7/18; B60L 58/15; B62J 45/41; F16D 55/226; B60L 2200/12; B60L 2240/425; B60L 2240/461; B60L 2240/54; B60L 2250/24; B60L 2250/26; B62L 3/023; B62L 3/04; F16D 2121/04

(57) ABSTRACT

A brake system for a vehicle includes: an actuator indicating a braking demand; a sensor sensing parameter(s) indicating the braking demand; and a controller operating a motor to regeneratively brake the vehicle and charge an energy storage device, and engaging a friction brake to frictionally brake the vehicle. The vehicle is braked only regeneratively in response to the braking demand not exceeding a first predetermined threshold, and the vehicle is braked regeneratively and frictionally in response to the braking demand exceeding the first predetermined threshold. The regenerative braking is controlled to not exceed an amount of electrical energy that the energy storage device is able to receive.

### CROSS-REFERENCE TO RELATED APPLICATIONS

The present application claims the benefit of, and priority to, U.S. Provisional Patent Application No. 63/418,830, filed on Oct. 24, 2022, which is expressly incorporated herein in its entirety by reference thereto.

### FIELD OF THE INVENTION

The present invention relates to a vehicle brake system, a vehicle including a vehicle brake system, and a method of operating a vehicle.

BACKGROUND INFORMATION Motor vehicles include, for example, brake systems to brake the vehicle. Friction brake systems include brake rotors or drums, brake pads, and actuators, e.g., calipers or cylinders, that press the brake pads against the brake rotors or drums to frictionally brake the vehicle. The actuators are operated mechanically, e.g., hydraulically, by the driver or operator of the vehicle. Frictionally braking results in heat energy, which is typically dissipated to the environment. This heat energy can cause excess wear on the components of the brake system, for example, by causing the brake rotors or drums to warp or wear down, the brake pads to wear down, etc. Excess heat can also cause brake fade, which may result in dangerous operating conditions of the vehicle. Additionally, friction braking converts the vehicle's kinetic energy into heat energy, which, when dissipated to the environment, is wasteful.

Regenerative brake systems recover the vehicle's kinetic energy during braking, in the form of electrical energy, by operating a motor in a generator mode, and the recovered electrical energy can be used to charge a battery of the vehicle.

### SUMMARY

It would be beneficial to maximize the amount of electrical energy that can be recovered via regenerative braking to increase the range of an electric vehicle, to reduce wear on, for example, brake rotors/disks, brake pads, etc., and to reduce, for example, brake fade. Thus, according to example embodiments, regenerative braking is prioritized over friction braking, and regenerative braking is utilized to the extent that a battery of the vehicle is able to accept electrical energy to charge the battery, and satisfying braking demand, in excess of maximum regenerative braking, is achieved by friction braking.

According to an example embodiment of the present invention, a brake system for a vehicle, which includes an energy storage device and an electric motor that is operable in a generator mode, includes: a brake actuator adapted to indicate a braking demand; a sensor adapted to sense at least one parameter indicating the braking demand based on actuation of the brake actuator; and a controller adapted to receive signals from the sensor indicating the braking demand, adapted to operate the motor in the generator mode to regeneratively brake the vehicle and charge the energy storage device, and adapted to engage a friction brake of the vehicle to frictionally brake the vehicle. The controller is adapted to: (a) operate the motor in the generator mode to brake the vehicle only regeneratively in response to the braking demand, indicated by the signals from the sensor, not exceeding a first predetermined threshold, to control the regenerative braking to the braking demand; and (b) operate the motor in the generator mode and engage the friction brake to simultaneously brake the vehicle regeneratively and frictionally in response to the braking demand, indicated by the signals from the sensor, exceeding the first predetermined threshold, to control the regenerative braking to not exceed an amount of electrical energy that the energy storage device is able to receive and to control a total amount of the regenerative braking and the friction braking to the braking demand.

According to an example embodiment of the present invention, a brake system for a vehicle, which includes an energy storage device and an electric motor that is operable in a generator mode, includes: a front brake actuator adapted to indicate a first braking demand of a front brake of the vehicle; a rear brake actuator adapted to indicate a second braking demand of a rear brake of the vehicle; a front brake sensor adapted to sense at least one parameter indicating the first braking demand based on actuation of the front brake actuator; a rear brake sensor adapted to sense at least one parameter indicating the second braking demand based on actuation of the rear brake actuator; and a controller adapted to receive signals from the front brake sensor indicating the first braking demand, adapted to receive signals from the rear brake sensor indicating the second braking demand, adapted to operate the motor in the generator mode to regeneratively brake the vehicle and charge the energy storage device, and adapted to engage a friction brake of the vehicle to frictionally brake the vehicle. The controller is adapted to: (a) operate the motor in the generator mode to brake the vehicle only regeneratively in response to a total braking demand, indicated by the signals from the front brake sensor and the rear brake sensor, not exceeding a first predetermined threshold, to control the regenerative braking to the total braking demand; and (b) operate the motor in the generator mode and engage the friction brake to simultaneously brake the vehicle regeneratively and frictionally in response to the total braking demand, indicated by the signals from the front brake sensor and the rear brake sensor, exceeding the first predetermined threshold, to control the regenerative braking to not exceed an amount of electrical energy that the energy storage device is able to receive and to control a total amount of the regenerative braking and the friction braking to the total braking demand.

According to an example embodiment of the present invention, a vehicle includes: an energy storage device; an electric motor operable in a generator mode; and a brake system. The brake system includes: a brake actuator adapted to indicate a braking demand; a sensor adapted to sense at least one parameter indicating the braking demand based on actuation of the brake actuator; and a controller adapted to receive signals from the sensor indicating the braking demand, adapted to operate the motor in the generator mode to regeneratively brake the vehicle and charge the energy storage device, and adapted to engage a friction brake of the vehicle to frictionally brake the vehicle. The controller is adapted to: (a) operate the motor in the generator mode to brake the vehicle only regeneratively in response to the braking demand, indicated by the signals from the sensor, not exceeding a first predetermined threshold, to control the regenerative braking to the braking demand; and (b) operate the motor in the generator mode and engage the friction brake to simultaneously brake the vehicle regeneratively and frictionally in response to the braking demand, indicated by the signals from the sensor, exceeding the first predetermined threshold, to control the regenerative braking to not exceed an amount of electrical energy that the energy storage device is able to receive and to control a total amount of the regenerative braking and the friction braking to the braking demand.

According to an example embodiment of the present invention, a method for operating a vehicle, which includes an energy storage device and an electric motor that is operable in a generator mode, includes: sensing, by a sensor of the vehicle, at least one parameter indicating a braking demand based on actuation of a brake actuator of the vehicle; receiving, by a controller of the vehicle, signals from the sensor indicating the braking demand; operating, by the controller, the motor in the generator mode to brake the vehicle only regeneratively in response to the braking demand, indicated by the signals from the sensor, not exceeding a first predetermined threshold, to control the regenerative braking to the braking demand; and operating, by the controller, the motor in the generator mode and engaging, by the controller, the friction brake to simultaneously brake the vehicle regeneratively and frictionally in response to the braking demand, indicated by the signals from the sensor, exceeding the first predetermined threshold, to control the regenerative braking to not exceed an amount of electrical energy that the energy storage device is able to receive and to control a total amount of the regenerative braking and the friction braking to the braking demand.

According to example embodiments, the brake actuator includes a lever and/or a pedal. According to example embodiments, the brake actuator includes a front brake lever adapted to engage a front friction brake of the vehicle and a rear brake pedal adapted to engage a rear friction brake of the vehicle.

According to example embodiments, the brake actuator is adapted to hydraulically engage the friction brake of the vehicle.

According to example embodiments, the controller is adapted to operate the motor in the generator mode and engage the friction brake to simultaneously brake the vehicle regeneratively and frictionally in response to the braking demand, indicated by the signals from the sensor, exceeding the predetermined threshold, to control the regenerative braking to approximately equal an amount of electrical energy that the energy storage device is able to receive and to control a total amount of the regenerative braking and the friction braking to the braking demand.

According to example embodiments, the vehicle is arranged as an electric motorcycle. According to example embodiments, the energy storage device includes a rechargeable battery.

According to example embodiments, the controller is adapted to monitor a temperature of the motor and to control the regenerative braking to not exceed a predetermined motor temperature threshold.

According to example embodiments, the controller is adapted to monitor a rotational wheel speed of a wheel of the vehicle and control the friction brake to prevent lock-up of the wheel.

According to example embodiments, the friction brake includes a brake disk, a brake caliper, a brake pad, and an actuator, the controller adapted to actuate the actuator to engage the friction brake to press the brake pad against the brake disk by the brake caliper.

According to example embodiments, the parameter includes a position of, a displacement of, a force exerted on, and/or a pressure exerted on the brake actuator.

According to example embodiments, the sensor includes a position sensor, a force sensor, and/or a pressure sensor.

According to example embodiments, the controller is adapted to communicate with the sensor, the motor, and the friction brake via a communication bus of the vehicle.

According to example embodiments, the communication bus includes a CAN bus.

According to example embodiments, the friction brake includes a front friction brake of the vehicle and/or a rear friction brake of the vehicle.

According to example embodiments, the friction brake is arranged as a front friction brake of the vehicle.

Further features and aspects of example embodiments of the present invention are described in more detail below with reference to the appended schematic Figures.

### BRIEF DESCRIPTION OF THE DRAWINGS

FIG. 1 is a side view of a vehicle including a vehicle brake system according to an example embodiment of the present invention.

FIG. 2 is a top view of the vehicle illustrated in FIG. 1.

FIG. 3 illustrates the vehicle brake system of the vehicle.

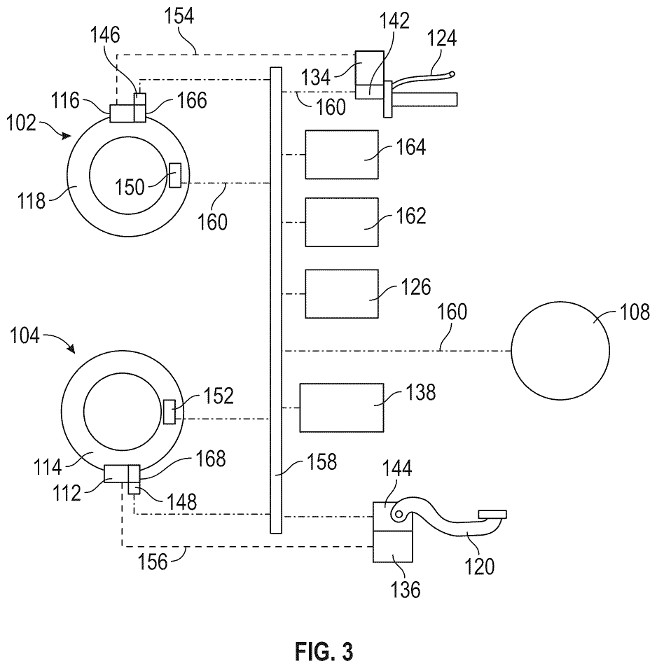

FIG. 4 graphically illustrates braking demand and battery charge power limit over time, in a simplified example.

FIG. 5 graphically illustrates braking demand, regenerative braking power, and mechanical braking power over time, in a simplified example.

FIG. 6 graphically illustrates braking demand, regenerative braking power, and mechanical braking power over time, in a more varied example than that illustrated in FIG. 5.

### DETAILED DESCRIPTION

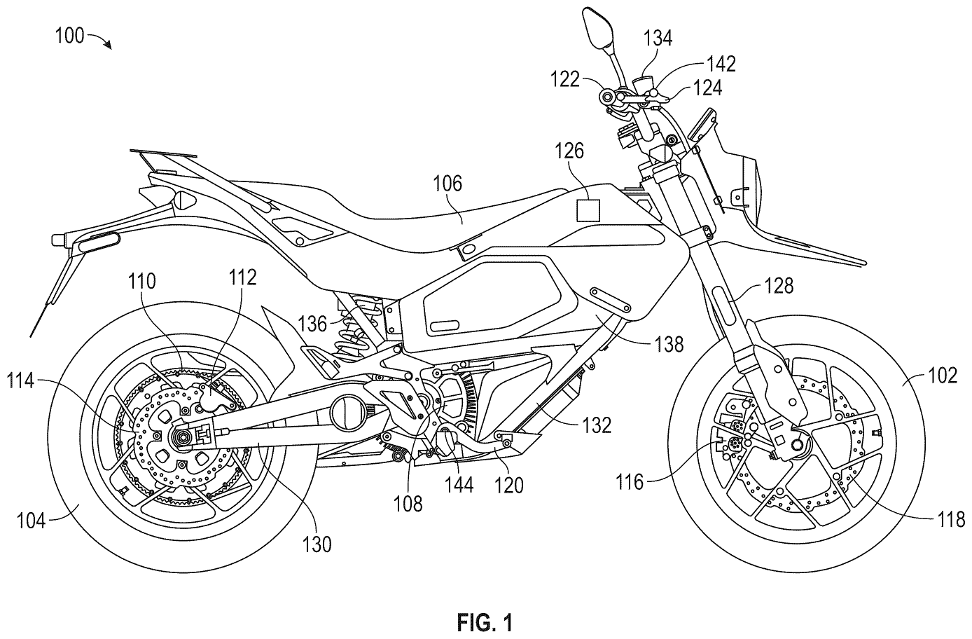

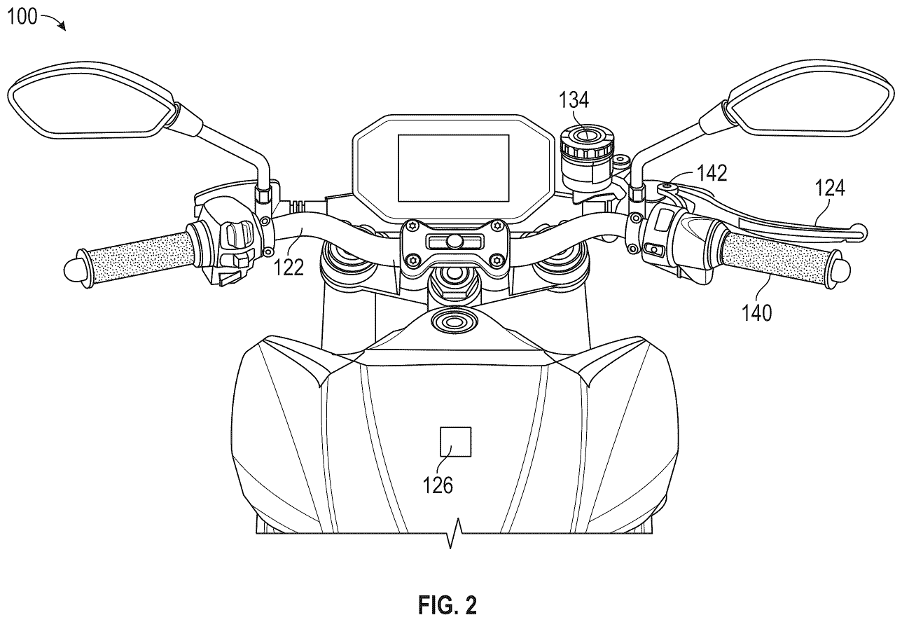

FIG. 1 is a side view of a vehicle 100 including a vehicle brake system according to an example embodiment of the present invention, and FIG. 2 is a top view of the vehicle 100. Vehicle 100 is illustrated in FIG. 1 as being arranged as a two-wheel vehicle, e.g., a motorcycle. It should be understood that vehicle 100 may be arranged as any type of vehicle having a brake system, including, for example, an automobile, scooter, all-terrain vehicle (ATV), quad, side-by-side, utility transport vehicle (UTV), truck, rail vehicle, military vehicle, etc. Additionally, vehicle 100 is described herein as being arranged as an electric vehicle (EV), e.g., a vehicle driven by an electric motor. However, vehicle 100 may be arranged as a hybrid vehicle, an engine-driven vehicle, etc.

As illustrated in FIG. 1, vehicle 100 includes a front wheel 102 and a rear wheel 104, which is driven by an electric motor 107 via, e.g., a chain 110, a belt, a drive shaft, etc. Vehicle 100 includes a seat 106 for accommodating a driver of the vehicle 100 and, optionally, a passenger. Vehicle further includes a handlebar 122 for steering the vehicle 100. Front wheel 102 includes a front brake disk or rotor 118 and is mounted to the front fork 128 of vehicle 100, and rear wheel 104 includes a rear brake disk or rotor 118 and is mounted to swingarm 130 of vehicle 100. A first brake actuator, e.g., a brake lever 124, is mounted on the handlebar 122, and a second brake actuator, e.g., a brake pedal 120, is mounted on the frame 132 of the vehicle 100. Actuation of the brake lever 124 causes front brake caliper 116 to press brake pads against the front brake disk 118, and actuation of the rear brake pedal 120 causes rear brake caliper 112 to press brake pads against the rear brake disk 114. Such pressing of brake pads against brake disks 114, 118 brakes the vehicle 100 by friction. The front and rear brake systems of vehicle 100 may operate hydraulically. For example, a front master cylinder 134 may contain a reservoir of hydraulic fluid, which, when pressurized, causes front brake caliper 116 to press the brake pads against the front brake disk 118, and a rear master cylinder 136 may contain a reservoir of hydraulic fluid, which, when pressurized, causes rear brake caliper 112 to press the brake pads against the rear brake disk 114. The front master cylinder 134 may be in fluid communication with the front brake caliper 116 via hydraulic line 154, and the rear master cylinder 136 may be in fluid communication with the rear brake caliper 112 via hydraulic line 156.

Vehicle 100 includes an energy storage device 138, e.g., a battery, a rechargeable battery, a lithium-ion battery, etc. Motor 108 and other electronic systems and components of vehicle 100 are powered by battery 138. Thus, motor 108 drives rear wheel 104 to propel the vehicle under the control of the driver of vehicle 100. The motor 108 may operate as a motor to propel vehicle 100 and may also operate as a generator to recharge battery 138. When motor 108 operates as a generator, the vehicle 100 experiences regenerative braking. A throttle 140 is mounted on handlebar 122 of vehicle and rotation of the throttle 140 from its rest position represents torque and/or drive demand by the driver of the vehicle 100. For example, rotating the throttle 140 toward the driver, e.g., in a counterclockwise direction viewed from the outboard terminal end of the throttle 140, may indicates positive torque demand to propel the vehicle 100 forward, whereas rotating the throttle 140 away from the driver, e.g., in a clockwise direction viewed from the outboard terminal end of the throttle 140, may indicate a negative torque demand, e.g., a demand for regenerative braking of the vehicle 100. The degree of rotation of the throttle 140 may indicate the degree of torque demand. For example, the degree of torque demand, whether positive or negative, may be proportional to the degree of rotation of throttle 140.

Controller 126 may be arranged as a single integrated unit, e.g., electronic control unit (ECU), or may include a plurality of units, e.g., ECUs, distributed throughout the vehicle 100. The controller 126 may include one or more processors, CPUs, etc., and one or more memory units storing, for example, software instructions, data, etc. The memory may be arranged as a non-transitory memory that stores a set of instructions that are executable by the processor(s), CPU(s), etc., to control various aspects, functions, components, etc., of the vehicle 100 under the control of, for example, the driver or operator of the vehicle 100. Vehicle 100 includes an antilock braking system (ABS) 164, which may be controlled and/or implemented by controller 126 and/or by one or more separate control unit(s) 162.

A front brake lever sensor 142 may be provided to detect the amount of front braking demanded by the driver of vehicle 100. For example, the front brake lever sensor 142 may be a rotational sensor adapted to detect the rotational displacement and/or position of the front brake lever 124, a position sensor adapted to detect an absolute and/or relative position of the front brake lever 124, angle sensor adapted to detect an absolute and/or relative angle of the front brake lever 124, a force sensor adapted to detect the amount of force exerted by the driver on the front brake lever 124, a pressure sensor adapted to detect the amount of pressure exerted by the driver on the front brake lever 124, a hydraulic pressure sensor adapted to detect the amount of hydraulic pressure generated in the hydraulic front brake system between front brake master cylinder 134 and front brake caliper 116, etc., and/or any combination of such sensors. A rear brake pedal sensor 144 may be provided to detect the amount of rear braking demanded by the driver of vehicle 100. For example, the rear brake pedal sensor 144 may be a rotational sensor adapted to detect the rotational displacement and/or position of the rear brake pedal 120, a position sensor adapted to detect an absolute and/or relative position of the rear brake pedal 120, angle sensor adapted to detect an absolute and/or relative angle of the rear brake pedal 120, a force sensor adapted to detect the amount of force exerted by the driver on the rear brake pedal 120, a pressure sensor adapted to detect the amount of pressure exerted by the driver on the rear brake pedal 120, a hydraulic pressure sensor adapted to detect the amount of hydraulic pressure generated in the hydraulic rear brake system between rear brake master cylinder 136 and rear brake caliper 112, etc., and/or any combination of such sensors. Multiple sensors may be provided at the front brake lever 124 and/or at the rear brake pedal 120 for redundancy and enhanced operations. For example, signals relating to the operation of the front brake lever 124 may be communicated to the controller 126 from a pressure sensor, adapted to sense the pressure in the front brake's hydraulic system, and/or from a lever position sensor, adapted to sense a position of the front brake lever 124. Thus, the front brake demand, for example, may be determined based on signals from multiple sensors, from a single sensor, etc. For example, signals relating to the operation of the rear brake pedal 120 may be communicated to the controller 126 from a pressure sensor, adapted to sense the pressure in the rear brake's hydraulic system, and from a pedal position sensor, adapted to sense a position of the rear brake pedal 120. Thus, the rear brake demand, for example, may be determined based on signals from multiple sensors, from a single sensor, etc. Signals from the sensors 142 and/or 144 may be communicated to controller 126.

Based on signals from sensors 142 and/or 144, controller 126 may operate hydraulic and/or mechanical actuator(s) 146, 148, e.g., a hydraulic pump powered by the electrical system of vehicle 100, to cause front and/or rear brake calipers 112, 116 to frictionally brake vehicle 100 and/or operate motor 108 as a generator to regeneratively brake vehicle 100 and simultaneously recharge battery 138. Additional signals may be provided to controller 126 and utilized by controller 126 in energizing and applying the front, rear, and/or regenerative braking. For example, the controller 126 may receive signals indicating maximum battery charge current, traction force available, e.g., from a traction control and/or antilock brake system or subsystem, drive-mode profile selection, etc.

In certain configurations, the braking system of the vehicle 100 is operable hydraulically and electronically. For example, the front caliper 116 may be operable hydraulically, based on operation of the front brake lever 124 pressurizing hydraulic fluid in the front master cylinder 134, and/or electronically, based on signals generated by the sensor 142 in response to operation of the front brake lever 124, and the rear caliper 112 may be operable hydraulically, based on operation of the rear brake pedal 120 pressurizing hydraulic fluid in the rear master cylinder 136, and/or electronically, based on signals generated by the sensor 144 in response to operation of the rear brake pedal 120. In certain configurations, the front brake system is operable both hydraulically and electronically, whereas the rear brake system is operated only electronically. In this configuration, the rear brake caliper 112 is engaged by actuator 148 in response to signals generated by sensor 144, and vehicle 100 does not include a rear master cylinder 136 or hydraulic line 156. In other words, there is no direct mechanical or hydraulic connection between the rear brake pedal 120 and the rear brake caliper 112.

The front brake lever 124 and/or the rear brake pedal 120 may be configured so that in one portion of their operating range, e.g., travel from their rest position(s), they operate the brake(s) of the vehicle 100 electronically, e.g., in a brake-by-wire mode, and in another portion of their operating range, e.g., travel from their rest position(s), they operate the brake(s) of the vehicle 100 mechanically, e.g., hydraulically. For example, the front brake system of the vehicle 100 may be configured so that in a first portion of travel of the front brake lever 124 from its rest position, the controller 126 operates the front actuator 146 to apply brake pressure by the front brake caliper 116, e.g., in a brake-by-wire mode, and so that in a second portion of travel, e.g., at full travel, the front brake caliper 116 applies braking pressure in response to hydraulic pressure generated by the front brake lever 124 and front master cylinder 134. The rear brake system may be configured in similar manner so that in a first portion of travel of the rear brake pedal 120 from its rest position, the controller 126 operates the rear actuator 148 to apply brake pressure by the rear brake caliper 112, e.g., in a brake-by-wire mode, and so that in a second portion of travel, e.g., at full travel, the rear brake caliper 112 applies braking pressure in response to hydraulic pressure generated by the rear brake pedal 120 and rear master cylinder 136. To enhance safety, e.g., to provide for fail-safe braking, a safety valve may be provided in the front and/or rear hydraulic brake system, which opens at a predetermined pressure, so that in the event of failure of, for example, the controller 126, the battery 138, motor 108, other electrical and/or electronic components of vehicle 100, etc., mechanical, frictional braking is available to the driver of vehicle 100, at either or both of the wheels 102, 104 The vehicle 100 may include an electrical and/or vehicle bus 158, to which other systems, subsystems, components, etc., of the vehicle 100 may be connected, as indicated by communication lines 160. Thus, the controller 126, for example, may communicate with and control systems, subsystems, components, etc., of the vehicle 100 via bus 158. Bus 158 may be arranged as a single bus or may include a plurality of buses. For example, bus 158 may include a CAN (Controller Area Network) bus.

The controller 126 may be adapted to operate the motor 108 in the generator mode to perform regenerative braking and to recover as much energy as possible while charging the battery 138. Recharging the battery 138 by regenerative braking increases, e.g., maximizes, the driving range of the vehicle 100, reduces mechanical wear on the brake pads and disks 114, 118, reduces brake fade, etc. The controller 126 may determine the amount of charge that the battery 138 is able to accept at any given time and control the regenerative braking by the motor 108 based on that parameter. For example, the controller 126 may limit the amount of regenerative braking by the motor 108 so that the battery 138 does not overheat, overcharge, degrade, become damaged, etc. The controller 126 may interface with the antilock brake system (ABS) of the vehicle 100 and control regenerative braking so that the vehicle 100 achieves the level of braking demanded by the driver, based on signals from the front brake lever 124 and/or rear brake pedal 120, without skidding or locking the front and/or rear brakes of vehicle 100. The ABS system of the vehicle 100 may include, for example, front wheel sensor 150 and rear wheel sensor 152, which respectively monitor the speed of the front wheel 102 and rear wheel 104, so that the ABS system can prevent the front and rear brake system from locking the wheels 102, 104 during braking. For example, the controller 126 may prioritize regenerative braking over frictional braking. Thus, for example, the controller 126 may be adapted to control the motor 108 to apply regenerative braking and limit the amount of regenerative braking based on one or more thresholds. In this regard, a first threshold may indicate the absolute maximum amount of regenerative braking that may be applied by the motor 108. This first threshold may be fixed and determined by the manufacturer of motor 108, vehicle 100, controller 126, etc. The first threshold may be determined at the time of design of, e.g., vehicle 100, at the time of manufacture, e.g., of vehicle 100, dynamically during operation of the vehicle 100, etc. A second threshold may indicate the maximum amount of regenerative braking that may be applied by the motor 108 based on operating conditions of the vehicle 100 and its components.

For example, the second threshold may be dynamically determined by the controller 126 based on, for example, current RPM of the motor 108, maximum battery charge current, maximum torque as indicated by the ABS system, pressure in front and/or rear brake lines, e.g., hydraulic lines, position of and/or force applied to front brake lever 124, position of and/or force applied to rear brake pedal 120, signals from sensors 142 and/or 144, maximum motor torque, motor temperature, battery temperature, etc.

Thus, the controller 126 may first apply regenerative braking, based on braking demand as indicated by signals from the sensors 142 and/or 144, up to the threshold(s), and may then apply friction braking, in the event that the braking demand exceeds the threshold(s). To control the amounts of friction braking, the controller 126 may control hydraulic pressure delivered to the front and/or rear brake calipers 112, 116 by, for example, controllable valve(s) provided in the front and/or rear master cylinder(s) 134, 136, hydraulic line(s) 154, 156, front and/or rear brake caliper(s) 112, 116, etc., and/or may control front and/or rear actuator(s) 146, 148.

For example, the controller 126 may monitor, e.g., continuously, periodically, in real time, etc., the maximum available battery charge power, the magnitude and ration of rear and front brake demand, e.g., based on signals from sensors 142, 144, vehicle speed and wheel traction, e.g., based on signals from wheel sensors 150, 152, vehicle orientation, e.g., based on signals from an inertial measurement unit of, for example, a stability control system of vehicle 100, etc. Based on these signals, the controller 126 may apply mechanical and/or regenerative braking to maintain vehicle stability while simultaneously maximizing the amount of energy recovered by regenerative braking and maintaining the expected feel of driving the vehicle, but without exceeding the braking demand of the driver of vehicle 100.

Controller 126 may communicate with a variety of components of the vehicle 100. For example, the controller 126 may communicate with: motor 108 and/or a motor controller to obtain information relating to motor speed, e.g., in RPM, motor torque, maximum motor torque, motor temperature, etc. ; battery 138 and/or a charge controller to obtain information relating to the maximum battery charge current, state of charge, state of discharge, temperature, etc.; ABS 164 to obtain information relating to maximum torque to avoid skidding or brake lock-up; pressure sensor(s) 166, 168 to obtain information relating to hydraulic pressure in hydraulic line(s) 154, 156; front brake lever sensor 142 to obtain information relating to the position, displacement, force, pressure, etc., of front brake lever 124; rear brake pedal sensor 144 to obtain information relating to the position, displacement, force, pressure, etc., of rear brake pedal 120; etc. The controller 126 may use one, all, and/or any combination of these parameters to control the frictional and/or regenerative braking, so that maximum energy is recovered, in the form of electrical energy to recharge the battery 108, without causing the vehicle 100 to skid or lose stability.

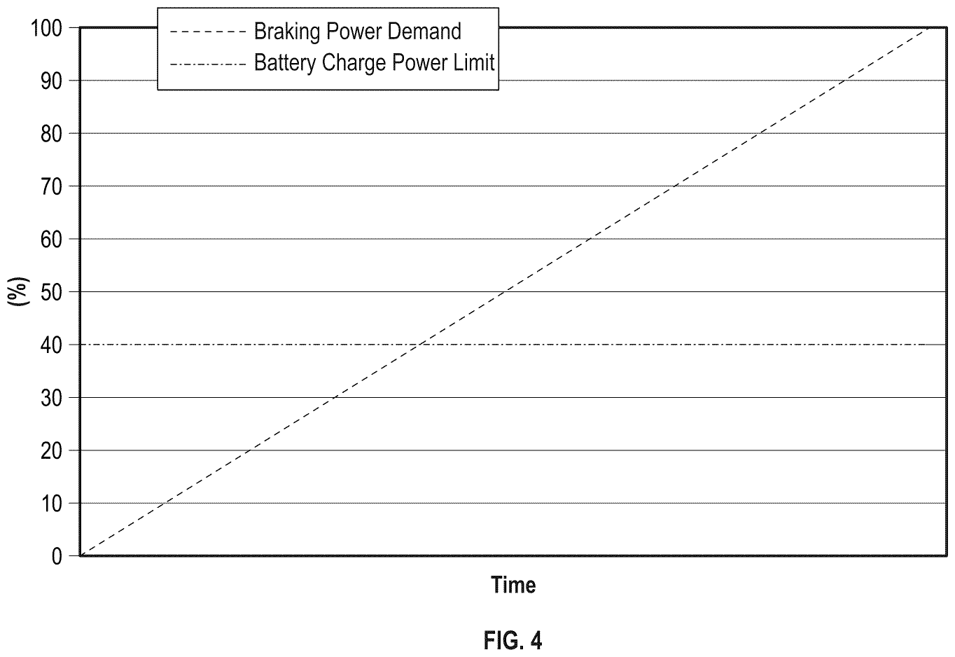

FIG. 4, for example, graphically illustrates braking demand, indicated by the dashed line, over time, in a simplified example, in which braking demand increases linearly from 0% to 100% over time. In FIG. 4, the abscissa represents time, and the ordinate represent braking percentage. FIG. 4 also illustrates a simplified example of battery charge power limit, which is, for example, 40% of the maximum braking that the vehicle's wheels are able to deliver.

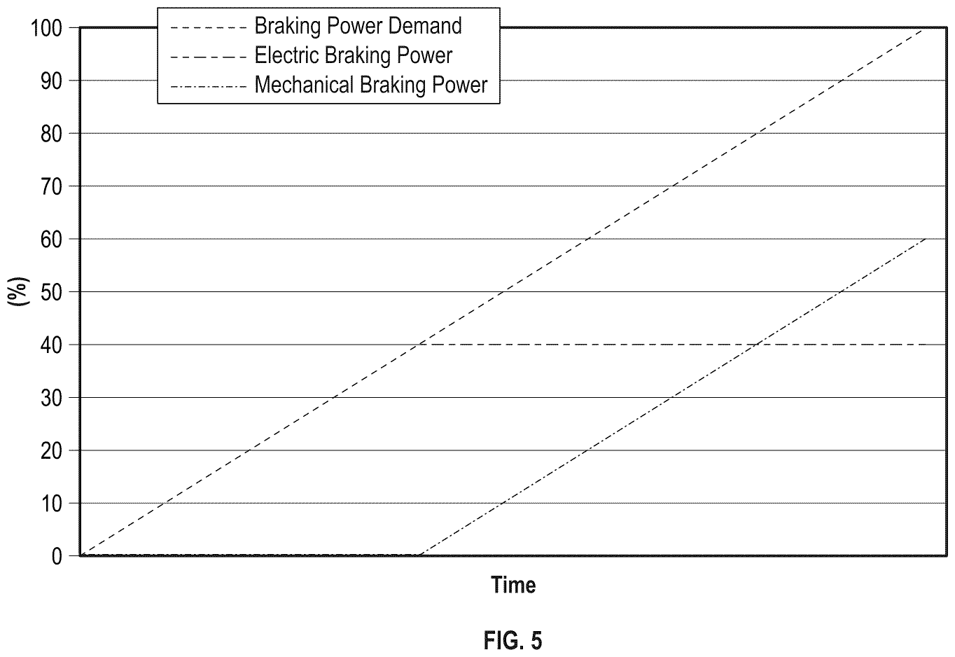

FIG. 5 graphically illustrates braking demand, regenerative braking power, and mechanical braking power over time, corresponding to the simplified example illustrated in FIG. 4. In FIG. 5, the dashed line indicates braking demand, the dotted line indicates regenerative braking, and the dash-dot line indicates mechanical braking. According to FIG. 5, as braking demand increase from 0% to 40%, only regenerative braking is applied, and as braking demand increases from 40% to 100%, regenerative braking is maintained at the maximum that the battery 138 is able to accept, i.e., 40% of maximum braking that the vehicle's wheels are able to deliver, and mechanical braking is applied so that the total braking, i.e., regenerative braking plus mechanical braking, satisfies the braking demand.

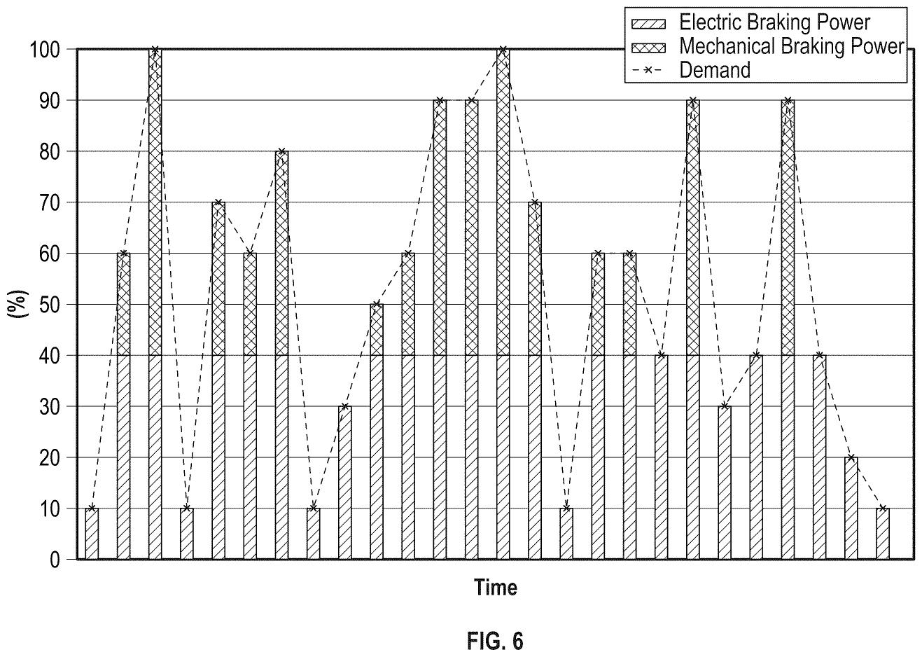

FIG. 6 graphically illustrates braking demand, regenerative braking power, and mechanical braking power over time, in a more varied example than that illustrated in FIG. 5. In FIG. 6, the dotted line indicates braking demand, the diagonally hatched bar indicates regenerative braking, and the cross hatched bar indicates mechanical braking. As illustrated in FIG. 6, while braking demand is at or below the maximum that the battery 138 is able to accept, i.e., 40% of maximum braking that the vehicle's wheels are able to deliver, braking is achieved by regenerative braking alone, whereas mechanical braking is applied once the braking demand exceeds that threshold so that the total braking, i.e., regenerative braking plus mechanical braking, satisfies the braking demand.

While FIGS. 4 to 6 illustrate a simplified example in which the maximum regenerative braking is constant, it should be understood that the maximum regenerative braking may vary and may depend on a number of parameters, including, for example, motor temperature, battery temperature, driving mode of the vehicle 100, age of the battery 138, the state of charge of the battery 138, ambient temperature, vehicle speed, etc.

Controller 126 may also communicate information to a variety of components of the vehicle 100. For example, the controller 126 may communication information to the motor 108 and/or a motor control unit, e.g., to prevent propulsion of the vehicle 100 in the forward and/or reverse directions unless one, or both, of the front brake lever 124 and the rear brake pedal 120 are engage, e.g., above a certain threshold of travel, force, pressure, etc. For example, controller 126 may prevent engaging a drive mode, unless signal(s) from front brake lever sensor 142 and/or rear brake pedal sensor 144 exceed predetermined threshold(s). As a further example, controller 126 may prevent changing a drive dynamics mode of the vehicle 100 unless signal(s) from front brake lever sensor 142 and/or rear brake pedal sensor 144 exceed predetermined threshold(s).

### LIST OF REFERENCE NUMERALS

100 Vehicle
102 Front Wheel
104 Rear Wheel
106 Seat
108 Motor
110 Chain
112 Rear Brake Caliper
114 Rear Brake Disk
116 Front Brake Caliper
118 Front Brake Disk
120 Rear Brake Pedal
122 Handlebar
124 Front Brake Lever
126 Controller
128 Front Fork
130 Swing Arm
132 Frame
134 Front Master Cylinder
136 Rear Master Cylinder
138 Battery
140 Throttle
142 Front Brake Lever Sensor
144 Rear Brake Pedal Sensor
146 Front Actuator
148 Rear Actuator
150 Front Wheel Sensor
152 Rear Wheel Sensor
154 Hydraulic Line
156 Hydraulic Line
158 Electrical Bus
160 Electrical Lines
162 Control Unit
164 Antilock Braking System
166 Front Pressure Sensor
168 Rear Pressure Sensor

What is claimed is:

1. A brake system for a vehicle that includes an energy storage device and an electric motor that is operable in a generator mode, comprising:
a brake actuator adapted to indicate a braking demand;
a sensor adapted to sense at least one parameter indicating the braking demand based on actuation of the brake actuator; and
a controller adapted to receive signals from the sensor indicating the braking demand, adapted to operate the motor in the generator mode to regeneratively brake the vehicle and charge the energy storage device, and adapted to engage a friction brake of the vehicle to frictionally brake the vehicle;
wherein the controller is adapted to: (a) operate the motor in the generator mode to brake the vehicle only regeneratively in response to the braking demand, indicated by the signals from the sensor, not exceeding a first predetermined threshold, to control the regenerative braking to the braking demand; and (b) operate the motor in the generator mode and engage the friction brake to simultaneously brake the vehicle regeneratively and frictionally in response to the braking demand, indicated by the signals from the sensor, exceeding the first predetermined threshold, to control the regenerative braking to not exceed an amount of electrical energy that the energy storage device is able to receive and to control a total amount of the regenerative braking and the friction braking to the braking demand.

2. The brake system according to claim 1, wherein the brake actuator includes a lever and/or a pedal.

3. The brake system according to claim 1, wherein the brake actuator includes a front brake lever adapted to engage a front friction brake of the vehicle and a rear brake pedal adapted to engage a rear friction brake of the vehicle.

4. The brake system according to claim 1, wherein the brake actuator is adapted to hydraulically engage the friction brake of the vehicle.

5. The brake system according to claim 1, wherein the controller is adapted to operate the motor in the generator mode and engage the friction brake to simultaneously brake the vehicle regeneratively and frictionally in response to the braking demand, indicated by the signals from the sensor, exceeding the predetermined threshold, to control the regenerative braking to approximately equal an amount of electrical energy that the energy storage device is able to receive and to control a total amount of the regenerative braking and the friction braking to the braking demand.

6. The brake system according to claim 1, wherein the vehicle is arranged as an electric motorcycle.

7. The brake system according to claim 1, wherein the energy storage device includes a rechargeable battery.

8. The brake system according to claim 1, wherein the controller is adapted to monitor a temperature of the motor and to control the regenerative braking to not exceed a predetermined motor temperature threshold.

9. The brake system according to claim 1, wherein the controller is adapted to monitor a rotational wheel speed of a wheel of the vehicle and control the friction brake to prevent lock-up of the wheel.

10. The brake system according to claim 1, wherein the friction brake includes a brake disk, a brake caliper, a brake pad, and an actuator, the controller adapted to actuate the actuator to engage the friction brake to press the brake pad against the brake disk by the brake caliper.

11. The brake system according to claim 1, wherein the parameter includes a position of, a displacement of, a force exerted on, and/or a pressure exerted on the brake actuator.

12. The brake system according to claim 1, wherein the sensor includes a position sensor, a force sensor, and/or a pressure sensor.

13. The brake system according to claim 10, wherein the controller is adapted to communicate with the sensor, the motor, and the friction brake via a communication bus of the vehicle.

14. The brake system according to claim 13, wherein the communication bus includes a CAN bus.

15. The brake system according to claim 1, wherein the friction brake includes a front friction brake of the vehicle and/or a rear friction brake of the vehicle.

16. A brake system for a vehicle that includes an energy storage device and an electric motor that is operable in a generator mode, comprising:
a front brake actuator adapted to indicate a first braking demand of a front brake of the vehicle;
a rear brake actuator adapted to indicate a second braking demand of a rear brake of the vehicle;
a front brake sensor adapted to sense at least one parameter indicating the first braking demand based on actuation of the front brake actuator;
a rear brake sensor adapted to sense at least one parameter indicating the second braking demand based on actuation of the rear brake actuator; and
a controller adapted to receive signals from the front brake sensor indicating the first braking demand, adapted to receive signals from the rear brake sensor indicating the second braking demand, adapted to operate the motor in the generator mode to regeneratively brake the vehicle and charge the energy storage device, and adapted to engage a friction brake of the vehicle to frictionally brake the vehicle;
wherein the controller is adapted to: (a) operate the motor in the generator mode to brake the vehicle only regeneratively in response to a total braking demand, indicated by the signals from the front brake sensor and the rear brake sensor, not exceeding a first predetermined threshold, to control the regenerative braking to the total braking demand; and
(b) operate the motor in the generator mode and engage the friction brake to simultaneously brake the vehicle regeneratively and frictionally in response to the total braking demand, indicated by the signals from the front brake sensor and the rear brake sensor, exceeding the first predetermined threshold, to control the regenerative braking to not exceed an amount of electrical energy that the energy storage device is able to receive and to control a total amount of the regenerative braking and the friction braking to the total braking demand.

17. The brake system according to claim 16, wherein the friction brake is arranged as a front friction brake of the vehicle.

18. The brake system according to claim 16, wherein the vehicle is arranged as an electric motorcycle.

19. A vehicle, comprising:
an energy storage device;
an electric motor operable in a generator mode; and
a brake system, including:
a brake actuator adapted to indicate a braking demand;
a sensor adapted to sense at least one parameter indicating the braking demand based on actuation of the brake actuator; and
a controller adapted to receive signals from the sensor indicating the braking demand, adapted to operate the motor in the generator mode to regeneratively brake the vehicle and charge the energy storage device, and adapted to engage a friction brake of the vehicle to frictionally brake the vehicle;
wherein the controller is adapted to: (a) operate the motor in the generator mode to brake the vehicle only regeneratively in response to the braking demand, indicated by the signals from the sensor, not exceeding a first predetermined threshold, to control the regenerative braking to the braking demand; and (b) operate the motor in the generator mode and engage the friction brake to simultaneously brake the vehicle regeneratively and frictionally in response to the braking demand, indicated by the signals from the sensor, exceeding the first predetermined threshold, to control the regenerative braking to not exceed an amount of electrical energy that the energy storage device is able to receive and to control a total amount of the regenerative braking and the friction braking to the braking demand.

20. A method for operating a vehicle that includes an energy storage device and an electric motor that is operable in a generator mode, comprising:
sensing, by a sensor of the vehicle, at least one parameter indicating a braking demand based on actuation of a brake actuator of the vehicle;
receiving, by a controller of the vehicle, signals from the sensor indicating the braking demand;
operating, by the controller, the motor in the generator mode to brake the vehicle only regeneratively in response to the braking demand, indicated by the signals from the sensor, not exceeding a first predetermined threshold, to control the regenerative braking to the braking demand; and
operating, by the controller, the motor in the generator mode and engaging, by the controller, the friction brake to simultaneously brake the vehicle regeneratively and frictionally in response to the braking demand, indicated by the signals from the sensor, exceeding the first predetermined threshold, to control the regenerative braking to not exceed an amount of electrical energy that the energy storage device is able to receive and to control a total amount of the regenerative braking and the friction braking to the braking demand.
